(19) United States
(12) Patent Application Publication
(10) Pub. No.: US 2026/0283135 A1
(43) Pub. Date: Sep. 24, 2026

(54) PEST CONTROL DEVICE AND ASSOCIATED PACKAGING METHODS

(71) Applicant: VMIP, LLC, Bedford, TX (US)

(72) Inventors: Ethan VICKERY, Colleyville, TX (US); Jay RASMUSSEN, Colleyville, TX (US)

(21) Appl. No.: 19/571,879

(22) Filed: Mar. 19, 2026

Related U.S. Application Data
(60) Provisional application No. 63/775,922, filed on Mar. 21, 2025.

(51) Int. Cl. A01M 1/10; B65D 71/00; B65D 75/00

(52) U.S. Cl. CPC A01M 1/106; B65D 71/0096; B65D 75/004

(57) ABSTRACT

A pest control device and packaging methods thereof, the pest control device comprising: a base comprising plastic; a lid comprising plastic configured to be movable relative to the base between an open configuration and a closed configuration in which the base and the lid cooperate to define an interior chamber, the lid defining an opening extending through the lid; and a grate configured to be coupled to the lid such that the grate covers the opening and, when the lid is in the closed configuration relative to the base, the grate extends away from the interior of the chamber.

### CROSS-REFERENCE TO RELATED APPLICATIONS

This application claims the benefit of priority of U.S. Provisional Patent Application No. 63/775,922, filed Mar. 21, 2025, which is hereby incorporated by reference in its entirety.

### FIELD OF INVENTION

The present invention relates generally to pest control devices, and more specifically, but not by way of limitation, to mosquito pest control devices and efficient methods of packing and transporting such devices.

### BACKGROUND

The use of pest control devices and methods to facilitate the capture, removal, relocation, extermination, or other form of population control of pests has been common practice for centuries. Pests can range from relatively small insects to large rodents or other animals, and can cause damage ranging from a minor nuisance to major, life-threatening damage. Mosquitos, a common pest throughout much of the world, can range from annoying to life-threatening due to their ability to transfer diseases and viruses such as: Malaria, West Nile Virus, Yellow Fever, Dengue Fever, Zika Virus, and the like. As such, controlling mosquito populations can greatly improve safety and quality of life. Thus, there is a need for effective, efficient, cost-effective, and long-lasting pest control devices to specifically target mosquito populations.

### SUMMARY

The present pest control devices can be utilized to control mosquito populations and mitigate the issues and dangers commonly associated with their presence.

In some configurations, the present pest control devices can comprise a base and a lid pivotably attached thereto such that when the lid is closed, the lid and the base can cooperate to define an interior chamber. An opening can be defined in the lid, and a grate can be configured such that it can be coupled to the lid to cover the opening. In some such configurations, the present pest control devices are configured to hold a volume of liquid (e.g., water) or other substances within the interior chamber such that an insecticide (e.g., insect growth regulator) or other treatment solution can be disposed in the interior chamber (e.g., to attract and/or poison mosquitos). In some such configurations, the present pest-control devices are configured to attract and/or permit mosquitos to enter the interior chamber to access a liquid and/or other substance disposed within the chamber. For example, in some configurations, the present pest control devices include a grate or other component that has a color (e.g., red) that contrasts with other parts of the device to initially attract mosquitos. In some such configurations, the grate includes openings to permit mosquitos to, upon coming closer to the grate, sense the humidity/moisture inside the interior chamber, which can further attract egg-laying mosquitos to enter the interior chamber through the grate openings and be exposed to an insecticide (e.g., insect growth regulator) and/or other substance in the interior chamber (e.g., in water in the interior chamber). As mosquitos naturally lay eggs on or near still water, the device (i.e., the interior chamber) can provide a location that mosquitos are believed to perceive as suitable to lay eggs. Additionally, sidewalls can be constructed within the interior chamber to allow for increased surface area for mosquitos to land, thereby increasing the potential for population control both in terms of quantity (e.g., amount of mosquitos/eggs by increasing available space) and duration (e.g., longevity of device viability before replacement/maintenance).

The grate can be designed such that it extends upward and away from the interior chamber to better attract mosquitos. However, for packaging and shipping purposes, the grate can be removably disposed within the interior chamber, thus reducing the volume required to house (and thus package) the device. For example, rather than transport the device with the grate attached to the lid, the grate can be held within the device (and the lid closed) for more efficient transportation. A user, when ready to set the device for use, can simply open the lid, remove the grate, and attach the grate to the lid. An anchoring base can additionally be utilized to ensure stability and placement of the device when utilized. In comparison with other devices on the market, the anchoring base of the present invention can be pre-manufactured and attached to the base before shipping. This can prove beneficial to a user as conventional devices typically require the user to make their own anchoring base, which can delay setup and add costs.

To ship multiple pest control devices, a packaged bundle or shipping bundle can be constructed that comprises: a pallet or transport pallet, a plurality of pest control devices, and a means for securement. For example, multiple pest control devices can be disposed on a pallet and secured via a strap or film. Furthermore, each device or multiple devices can be disposed within packaging containers to further facilitate the securement of the devices. Packing material can be used to further add support, thereby facilitating minimal movement of devices relative to each other and to the pallet. By combining such transportation methods (e.g., a pallet on which multiple packaging containers are disposed and secured via a film, each of the packaging containers holding one or more devices) with the low-volume device, the multiple devices can be shipped and delivered efficiently, thereby reducing costs and allowing for more efficient distribution of devices.

In some embodiments, the pest control device comprises: a base comprising plastic; a lid comprising plastic configured to be movable relative to the base between an open configuration and a closed configuration in which the base and the lid cooperate to define an interior chamber, the lid defining an opening extending through the lid; and a grate configured to be coupled to the lid such that: the grate covers the opening; and when the lid is in the closed configuration relative to the base, the grate extends away from the interior chamber.

In some embodiments, the pest control device further comprises an anchoring base comprising concrete that is pre-molded to correspond to at least one feature of the pest control device.

In some embodiments, the lid is movable relative to the base.

In some embodiments, the lid is pivotably coupled to the base.

In some embodiments, the grate is configured to be removably disposed within the chamber when the lid is in the closed configuration relative to the base.

In some embodiments, the grate comprises an upper end, a lower end, and one or more peripheral sidewalls extending between the upper end and the lower end, where the lower end is configured to engage the lid to couple the grate to the lid.

In some embodiments, the one or more sidewalls of the grate each define a plurality of openings.

In some embodiments, when the grate is coupled to the lid: the openings defined by the grate are configured to permit mosquitos to enter the chamber; and the upper end of the grate is configured to prevent rainfall from entering the chamber through the upper end.

In some embodiments, the lid further defines one or more channels configured to receive corresponding projections of the lower end of the grate.

In some embodiments, the lower end of the grate includes one or more projections configured to extend into corresponding ones of the one or more channels in the lid.

In some embodiments, the device further comprises a lock mechanism configured to latch to resist separation of the lid from the base when the lid is in the closed configuration relative to the base.

In some embodiments, the lid defines a key opening configured to permit access to the lock mechanism, and the device further comprises a key configured to be inserted through the key opening to actuate the lock mechanism.

In some embodiments, the anchoring base is configured to be coupled to the base.

In some embodiments, the at least one feature of the pest control device includes a curved portion of a perimeter of the pest control device and the anchoring base includes a first curved portion that corresponds to the curved portion of the perimeter of the pest control device.

In some embodiments, the pest control device packaged bundle comprises: a pallet; multiple pest control devices positioned on the pallet, where the multiple pest control devices are positioned on the pallet such that the pallet supports the multiple pest control devices, each of the multiple pest control devices comprising: a base comprising plastic; a lid comprising plastic configured to be movable relative to the base between an open configuration and a closed configuration in which the base and the lid cooperate to define an interior chamber, the lid defining an opening extending through the lid; and a grate configured to be coupled to the lid such that: the grate covers the opening; and when the lid is in the closed configuration relative to the base, the grate extends away from the interior chamber; and a means for securement.

In some embodiments, the packaged bundle comprises multiple pest control devices, wherein each of the pest control devices includes an anchoring base comprising concrete that is pre-molded to correspond to at least one feature of the pest control device.

In some embodiments, the means for securement of the pest control device packaged bundle comprises a film wrapped around a portion of the multiple pest control devices.

In some embodiments, the means for securement of the pest control device packaged bundle comprises a strap wrapped around a portion of the multiple pest control devices.

In some embodiments, the means for securement of the pest control device packaged bundle comprises a packaging container wrapped around a portion of the multiple pest control devices.

In some embodiments of the packaged bundle, the multiple pest control devices are secured to the pallet.

In some embodiments, the packaged bundle further comprises one or more keys coupled to one or more of the multiple pest control devices.

In some embodiments of the packaged bundle, at least one of the multiple pest control devices are disposed within a container that is positioned on the pallet.

In some embodiments, the shipping bundle comprises: a transport pallet; a plurality of pest control devices, each comprising: a base comprising plastic; a lid comprising plastic configured to be movable relative to the base between an open configuration and a closed configuration in which the base and the lid cooperate to define an interior chamber, the lid defining an opening extending through the lid; a grate configured to be coupled to the lid such that: the grate covers the opening; and when the lid is in the closed configuration relative to the base, the grate extends away from the interior chamber; and a means for securement.

In some embodiments, the shipping bundle comprises multiple pest control devices, wherein each of the pest control devices includes an anchoring base comprising concrete that is pre-molded to correspond to at least one feature of the pest control device.

In some embodiments, the means for securement of the pest control device shipping bundle comprises a plastic film wrapped around a portion of the plurality of pest control devices to secure the pest control devices to the transport pallet and restrict movement of pest control devices relative to each other.

In some embodiments, the means for securement of the pest control device shipping bundle comprises a strap securing the pest control devices to the transport pallet, the strap restricting movement of pest control devices relative to each other.

For some embodiments, a method for assembling the pest control device comprises: opening the lid; removing the grate from the chamber of the pest control device; closing the lid; and attaching the grate to the lid.

For some embodiments, a method for assembling the pest control device comprises: inserting the key into the key opening to actuate the lock mechanism; opening the lid; removing the grate from the chamber of the pest control device; closing the lid; and attaching the grate to the lid.

For some embodiments, the method for assembling the pest control device further comprises attaching the grate to the lid by inserting the one or more projections of the grate into a corresponding one of the one or more channels in the lid.

For some embodiments, the method for attaching the grate to the lid can further comprise: deforming the grate to fit the one or more projections into a corresponding one of the one or more channels in the lid; rotating the grate to fit the one or more projections into a corresponding one of the one or more channels in the lid; or applying downward pressure onto the grate to fit the one or more projections into a corresponding one of the one or more channels in the lid.

In some embodiments, the anchoring base includes: an anchoring base top surface having a portion that is in contact with the base and one or more anchoring base attachment surfaces that are not parallel to the anchoring base top surface.

In some embodiments, the pest control device further includes: one or more attachment pieces respectively in contact with the one or more anchoring base attachment surfaces; and one or more fastening members in contact with the base and respectively coupled to the one or more attachment pieces; where: the anchoring base is fixed to the base by a compressive force that is normal to the anchoring base top surface, the compressive force being applied to the anchoring base by the one or more attachment pieces; and the one or more attachment pieces are not integral to the anchoring base prior to respectively coupling the one or more fastening members to the one or more attachment pieces.

In some embodiments, the one or more attachment pieces are frusto-conically shaped fastening plugs that are respectively in contact with one or more fastening members.

In some embodiments, the one or more anchoring base attachment surfaces are frusto-conically shaped.

In some embodiments, the one or more attachment pieces are part of an attachment tray.

The term “coupled” is defined as connected, although not necessarily directly, and not necessarily mechanically. Two items that are “coupled” may be unitary with each other or may be connected to one another via one or more intermediate components or elements.

The terms “a” and “an” are defined as one or more unless this disclosure explicitly requires otherwise.

The term “substantially” is defined as largely, but not necessarily wholly, what is specified (and includes what is specified, e.g., substantially 90 degrees includes 90 degrees, and substantially parallel includes parallel) as understood by a person of ordinary skill in the art. Additionally, “substantially parallel” means within 10 degrees of parallel to, and “substantially perpendicular” means within 10 degrees of perpendicular to. In any disclosed embodiment, the terms “substantially,” “approximately,” and “about” may be substituted with “within [a percentage] of” what is specified, where the percentage is 1, 5, or 10%.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

The terms “comprise” (and any form thereof such as “comprises” and “comprising”), “have” (and any form thereof such as “has” and “having”), and “include” (and any form thereof such as “includes” and “including”), and “contain” (and any form of contain, such as “contains” and “containing”) are open-ended linking verbs. As a result, an apparatus or system that “comprises,” “has,” “includes,” or “contains” one or more elements possesses those one or more elements but is not limited to possessing only those one or more elements. Likewise, a method that “comprises,” “has,” “includes,” or “contains” one or more steps possesses those one or more steps but is not limited to possessing only those one or more steps.

Any embodiment of any of the apparatuses, systems, and methods can consist of or consist essentially of—rather than comprise/have/include/contain—any of the described steps, elements, and/or features. Thus, in any of the claims, the term “consisting of” or “consisting essentially of” can be substituted for any of the open-ended linking verbs recited above in order to change the scope of a given claim from what it would otherwise be using the open-ended linking verb.

Further, an apparatus or system that is configured in a certain way is configured in at least that way, but it can also be configured in other ways than those specifically described.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale unless otherwise noted, meaning the sizes of the depicted elements in each are accurate relative to each other for at least the embodiment shown.

FIGS. 1A-1G are perspective, top, bottom, front, rear, left, and right views, respectively, of an embodiment of the present pest control devices.

FIGS. 2A and 2B are perspective and top views, respectively, of the pest control device of FIGS. 1A-1G with the lid removed.

FIGS. 3A-3E are perspective, top, bottom, front, and side views, respectively, of the grate used with the pest control device of FIGS. 1A-1G.

FIGS. 4A and 4B are perspective and top views, respectively, of the pest control device of FIGS. 1A-1G with the grate removed.

FIGS. 5A-5G are perspective, top, bottom, front, rear, left, and right views, respectively, of the pest control device of FIGS. 1A-1G with an anchoring base attached.

FIGS. 6A-6G are perspective, top, bottom, front, rear, left, and right views, respectively, of the pest control device of FIGS. 1A-1G in an open configuration with the grate held within the interior chamber.

FIG. 7 is a magnified section view of a fastening member and attachment piece taken along lines 7-7 of FIGS. 6B and 6C.

FIG. 8 is a side view of a packaged bundle that can be used to transport multiple pest control device of FIGS. 1A-1G.

FIG. 9 is a side view of a shipping bundle that can be used to transport multiple pest control device of FIGS. 1A-1G.

FIG. 10 is a perspective view of a key that can be used to actuate the lock mechanism of the device of FIGS. 1A-1G.

### DETAILED DESCRIPTION

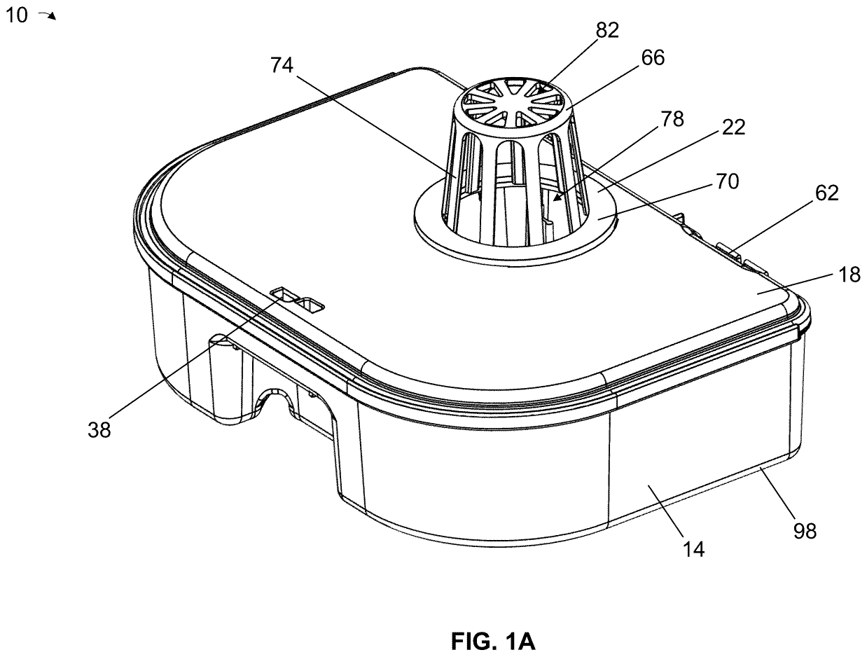

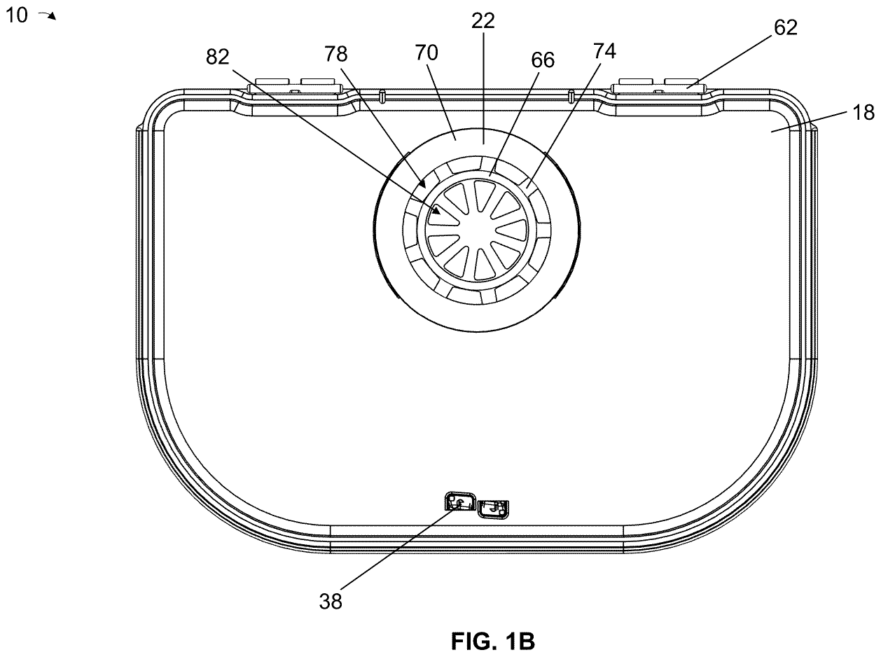

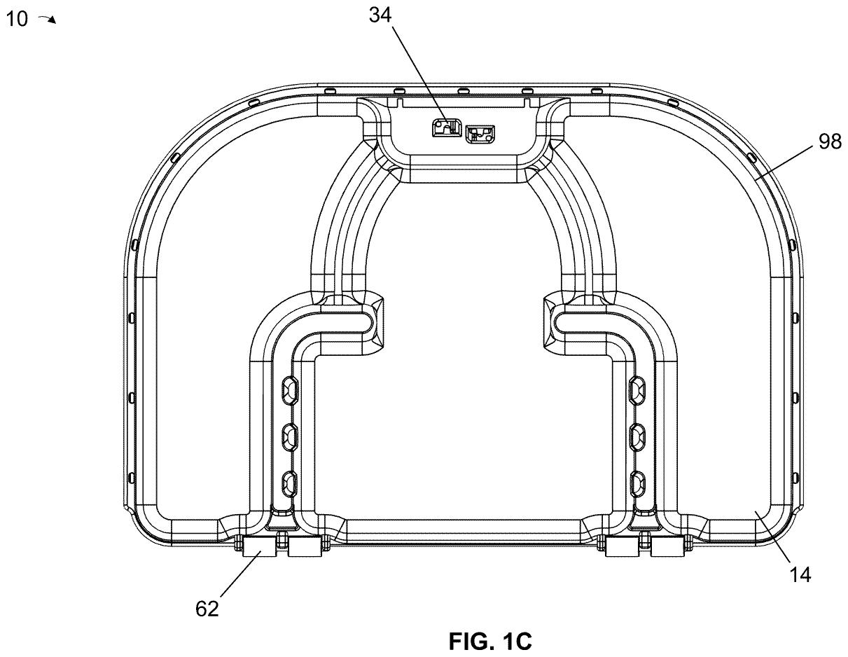

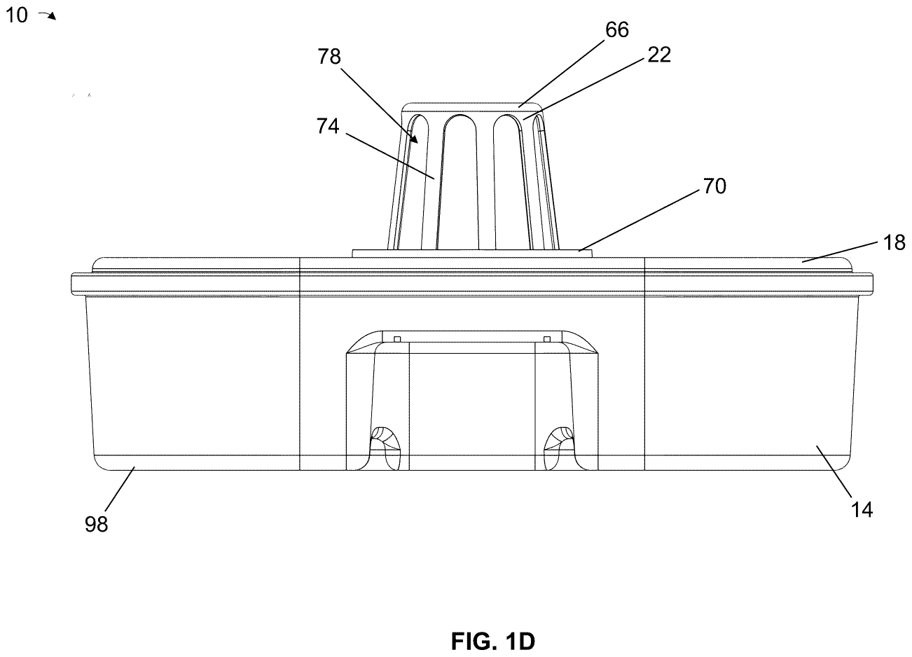

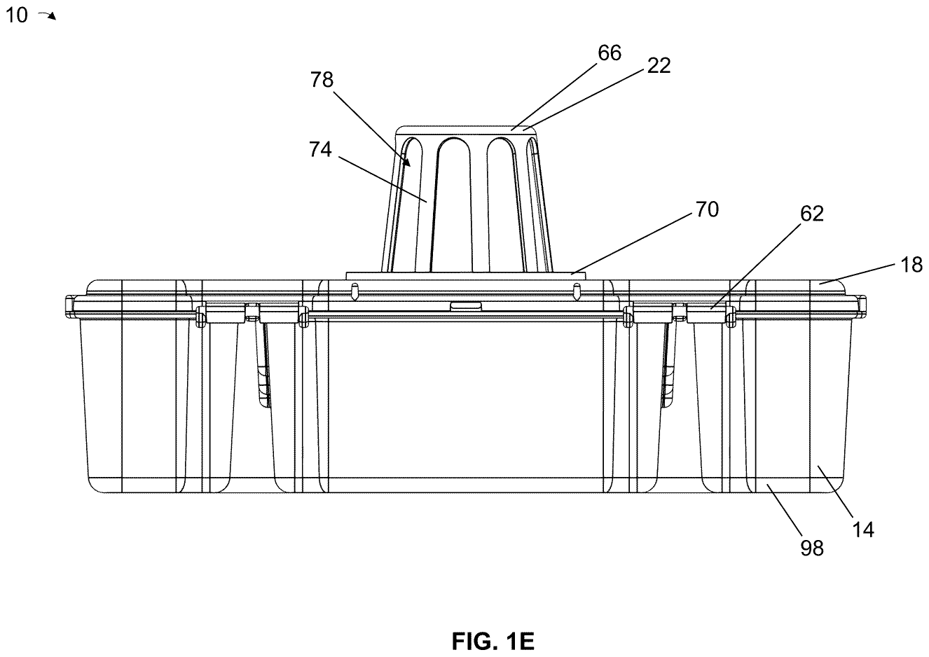

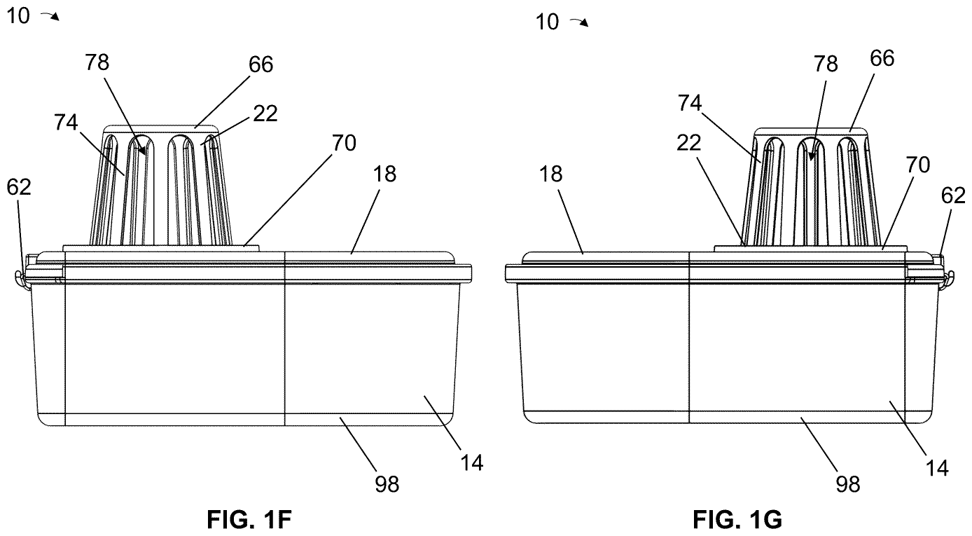

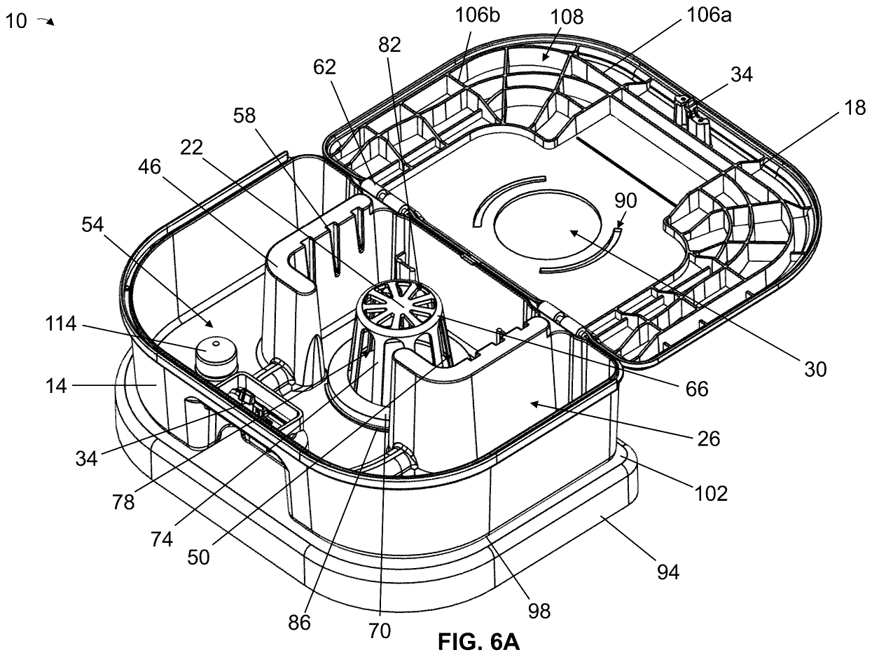

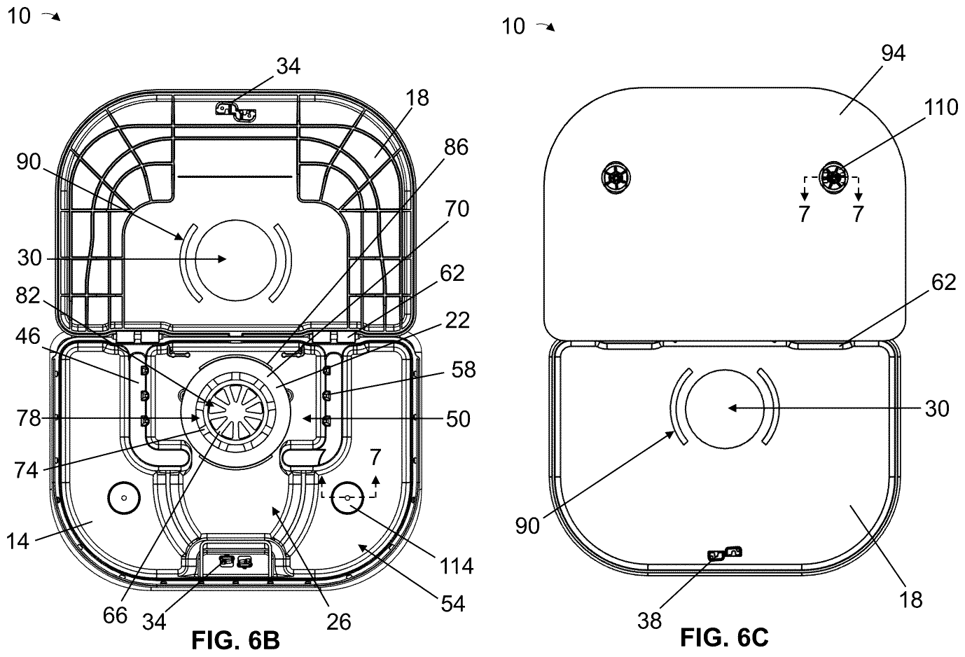

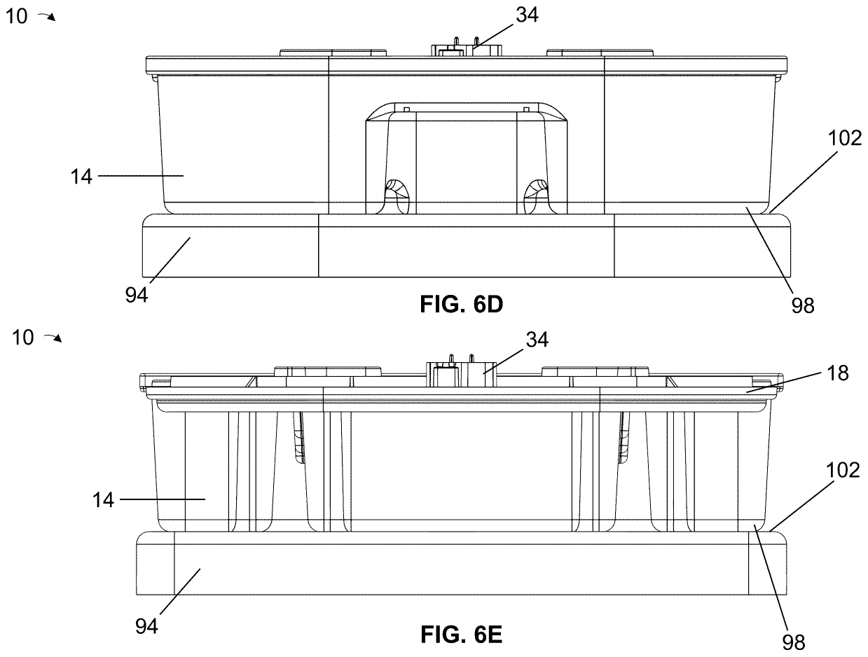

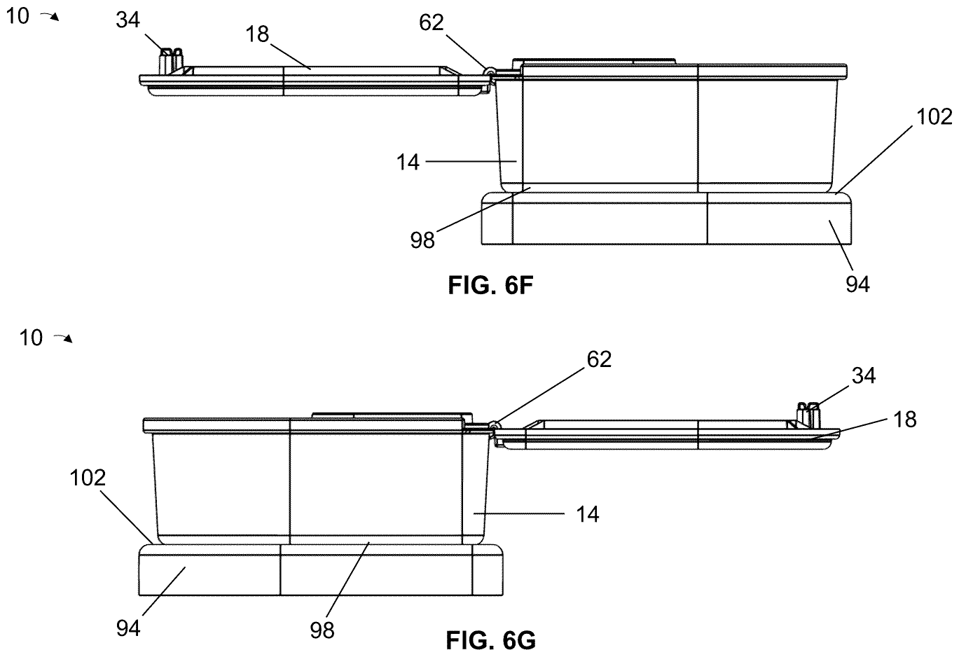

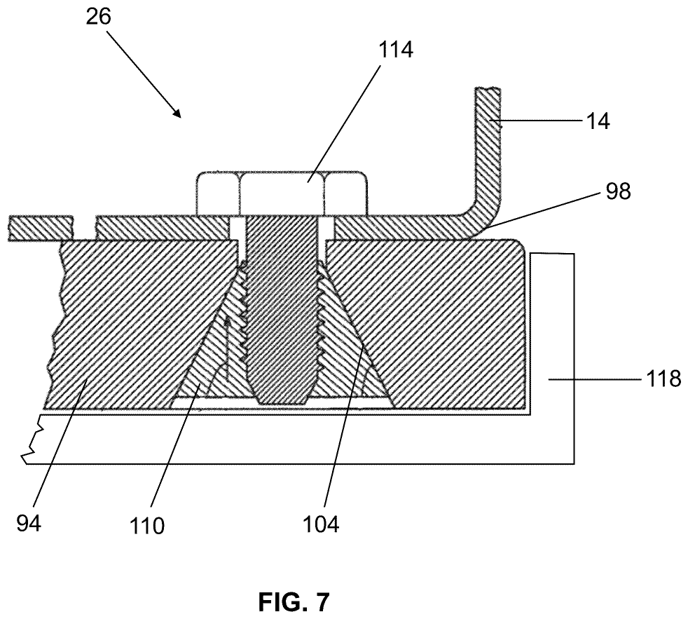

Referring now to the drawings, FIGS. 1A-1G depict a first example 10 of the present pest control devices configured to facilitate attraction and control of pests (e.g., mosquitos). In the depicted configuration, device 10 comprises a base 14, a lid 18, and a grate 22. Lid 18 is configured to be coupled to base 14 such that the lid is movable between a closed configuration (FIG. 1A) and an open configuration (FIG. 6A) relative to the base. In the closed configuration, base 14 and lid 18 cooperate to define an interior chamber 26 in which an insecticide (e.g., insect growth regulator) and/or other substance (e.g., water) can be disposed. For example, in some configurations, device 10 includes water and an insecticide in interior chamber 26. The insecticide can, for example, be or include an insect growth regulator configured to disrupt or interfere with the life cycle of insects (e.g., mosquitos) to reduce, maintain, or otherwise manage populations (e.g., over a period of time). As shown, lid 18 defines an opening 30 extending through the lid (e.g., to permit pests to enter the trap when the lid is in the closed configuration). A grate 22 can be configured to be coupled to lid 18, and more specifically, coupled such that the grate covers opening 30. In some configurations, such as the one shown, when lid 18 is in the closed configuration relative to base 14, grate 22 extends outward from the lid and away from interior chamber 26. By extending away from interior chamber 26, grate 22 can provide a greater area, as compared to a flat or planar grate that is parallel with the upper surface of the lid, through which openings can be defined to permit entry of pests (e.g., mosquitos).

In the depicted configuration, device 10 can be used to attract and control populations of pests (e.g., mosquitos) by partially filling interior chamber 26 with water, and the lid 18 closed to provide an environment in which mosquitos can lay eggs. As will be appreciated by those of skill in the art, the enclosed environment of interior chamber 26 can mimic desirable conditions that pests (e.g., mosquitos) often look for when laying eggs. For example, at least portions of interior chamber 26 will be dark and humid (e.g., due to being enclosed by the lid). A pesticide or the like can be disposed within the water or otherwise within device 10 to facilitate the killing of mosquitos or eggs that enter or are deposited within interior chamber 26, for example by interfering with development and hatching of eggs laid in the water, by interfering with the life cycle of mosquitos laying eggs in the water, or both.

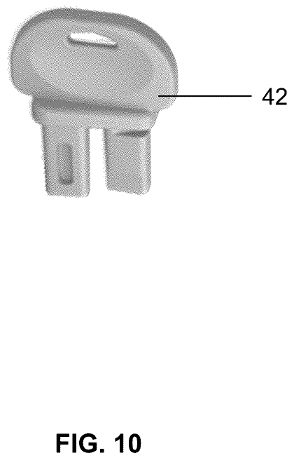

In some configurations, device 10 can comprise a lock mechanism 34 configured to latch or otherwise resist separation of lid 18 from base 14 when the lid is in the closed configuration relative to the base. Lock mechanism 34 can prove beneficial by ensuring that lid 18 is not accidentally or unintentionally moved into the open configuration relative to base 14. Furthermore, device 10 can additionally comprise a key opening 38 (e.g., defined by lid 18) configured to permit access to lock mechanism 34. Furthermore, device 10 can include a key 42 (see FIG. 10) configured to be inserted through key opening 38 to actuate lock mechanism 34, thereby allowing a user to move lid 18 to the open configuration and permit access to interior chamber 26.

Lid 18, when not in the closed configuration (and locked) relative to base 14, can be configured to move relative to the base. For example, as shown, lid 18 is pivotably coupled to base 14 to facilitate repeated opening and closing of device 10 while ensuring alignment between the lid and the base. For example, device 10 can comprise one or more hinge(s) 62 to facilitate movement of lid 18 relative to base 14. In the depicted configuration, two such hinges 62 are utilized to facilitate the desired movement, although any number of hinges could be utilized. However, lid 18 can alternatively be coupled to base 14 in any of a variety of manners, and, for example, may be completely removable from the base when lock mechanism 34 has been released. In some such configurations, the device 10 does not include any hinge between the lid and the base.

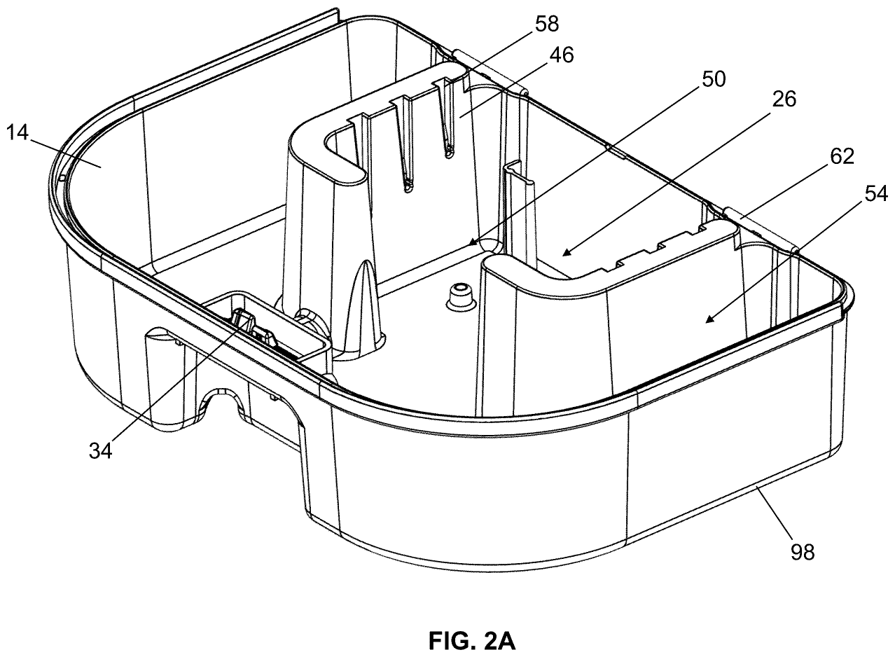

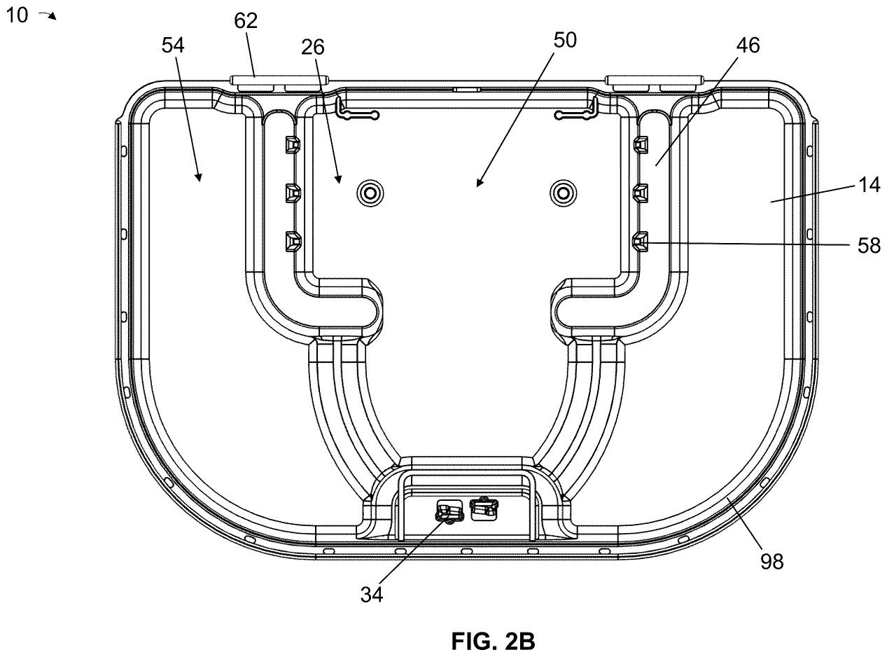

Referring now to FIGS. 2A and 2B, base 14 of device 10 is shown without lid 18 to further illustrate details of the interior chamber 26 in the depicted example. As shown, base 14 comprises one or more sidewall(s) 46 disposed within interior chamber 26. In some such configurations, the one or more sidewall(s) 46 can segment interior chamber 26, further defining a central cavity 50 and a peripheral cavity 54. Central cavity 50 and peripheral cavity 54 can be in fluid communication such that, when liquid is disposed within one of the cavities, said liquid can fill both cavities simultaneously. In some configurations, such as the one shown, interior chamber 26 or a part of the interior chamber (e.g., central cavity 50) can be configured to receive grate 22 (for example, during shipping or storage when device 10 is not actively being used for pest control). More specifically, grate 22 can be configured such that it is removably disposed within interior chamber 26 (e.g., central cavity 50) and lid 18 can be in the closed configuration relative to base 14 to secure the grate within the interior chamber. The placement of grate 22 within interior chamber 26 can be beneficial, for example, when transporting or storing the device, for example, to minimize the volume needed during shipping, storage, or both.

In addition to defining central cavity 50 and peripheral cavity 54, the one or more sidewall(s) 46 can facilitate enticing conditions for pests (e.g., mosquitos) to land and deposit eggs within device 10. To illustrate, the one or more sidewall(s) 46 can act as a barrier to reduce or slow the movement of liquid within interior chamber 26. As will be well known to those of skill in the art, mosquitos generally prefer still water when laying eggs. Therefore, the mitigation of water movement (e.g., due to wind or other external influences) can increase the likelihood of pests such as mosquitos entering and interacting with water in interior chamber 26, such as to lay eggs. The one or more sidewall(s) 46 can also provide increased surface area for pests (e.g., mosquitos) to land on and deposit eggs. For example, sidewall(s) 46 can be textured or shaped, such as by defining one or more cutout(s) 58, further increasing surface area available to pests (e.g., mosquitos), thereby facilitating increased efficiency and longevity of device 10.

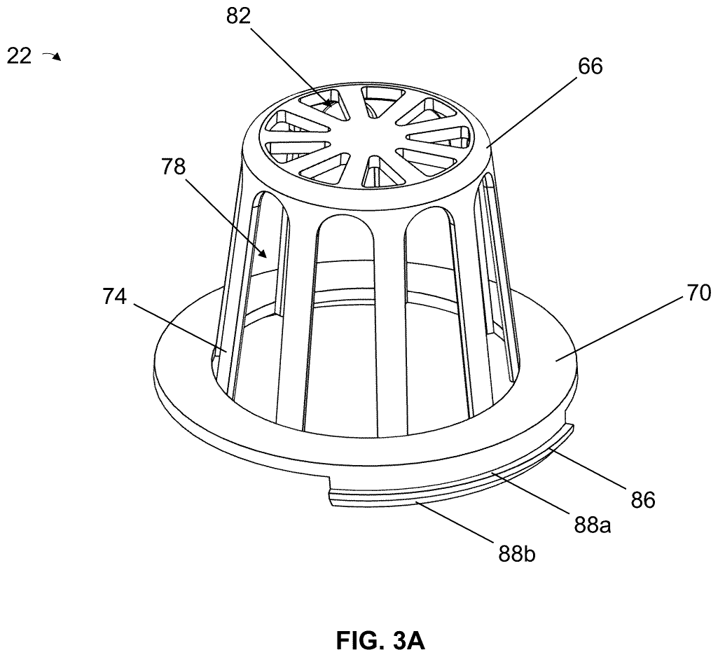

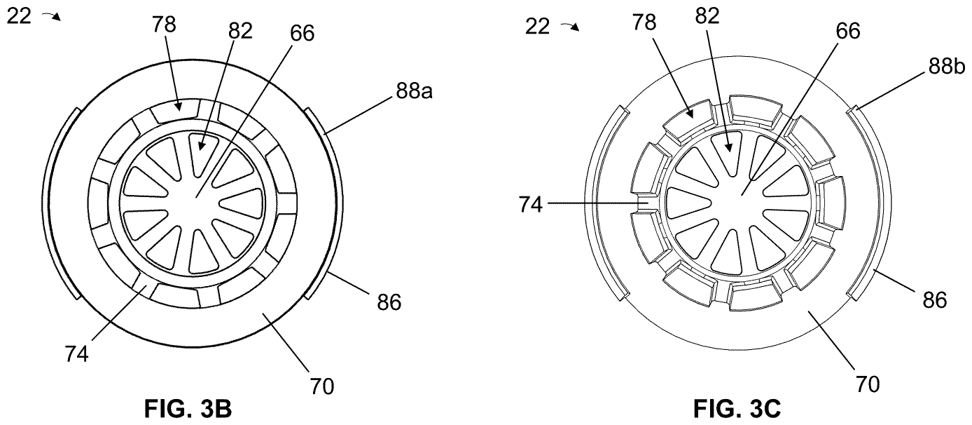

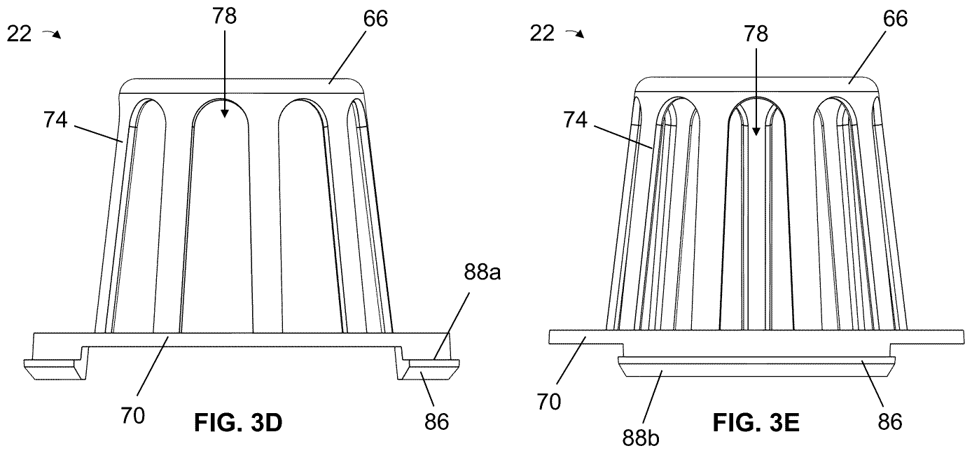

Referring now to FIGS. 3A-3E, one example of grate 22 is shown from a variety of views. Grate 22, configured to be coupled to lid 18, can facilitate the movement of pests (e.g., mosquitos) into device 10 (e.g., into interior chamber 26 via opening 30). As was previously described, grate 22 can be configured such that it covers opening 30 and extends away from interior chamber 26 (e.g., when lid 18 is in the closed configuration relative to base 14). In the depicted configuration, grate 22 comprises an upper end 66, a lower end 70, and one or more peripheral sidewalls 74 extending between the upper end and lower end. Lower end 70 of grate 22 is configured to engage with lid 18, thereby selectively coupling the grate to the lid. In some configurations, such as the one shown, the one or more peripheral sidewalls 74 of grate 22 each define a plurality of openings 78. Thus, when grate 22 is coupled to lid 18 (e.g., covering opening 30 as shown in FIG. 1A), the openings 78 defined by the grate can permit pests (e.g., mosquitos) to enter device 10, or more specifically, interior chamber 26. In some configurations, upper end 66 of grate 22 can be configured to prevent rainfall from entering interior chamber 26 from the upper end. In yet other configurations, such as the one shown, upper end 66 of grate 22 can be configured to permit pests (e.g., mosquitos) to enter interior chamber 26 through additional openings 82. In this configuration, when placed outdoors, the additional openings 82 in upper end 66 of grate 22 also permit at least a portion of any rainfall reaching the grate to fall into the interior chamber, thereby at least partially replenishing water that may be lost due to evaporation. In other configurations, such as those intended for use indoors, upper end 66 of grate 22 may be solid to reduce evaporation and/or reduce the amount of light permitted to reach interior chamber 26. In some configurations, such as the one shown, grate 22 includes one or more projection(s) 86, each of which can be used to further facilitate coupling of grate 22 to lid 18. More particularly, in the depicted configurations, each projection 86 has a shape corresponding to the shape of a respective channel or opening in lid 18, and includes an upward facing ledge 88a and an angled or tapered lower portion 88b such that the projection will snap into the corresponding channel or opening and the ledge will resist removal therefrom (and thereby resist separation of grate 22 from the lid).

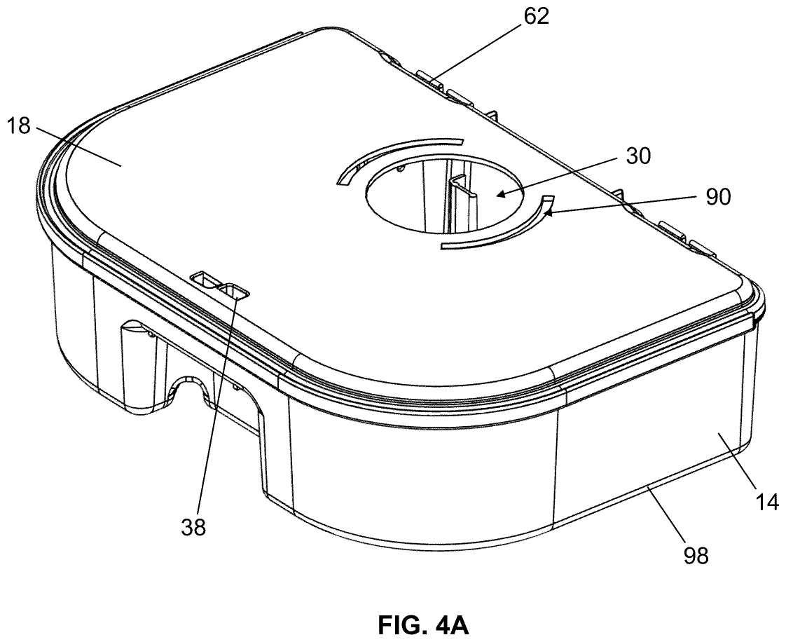

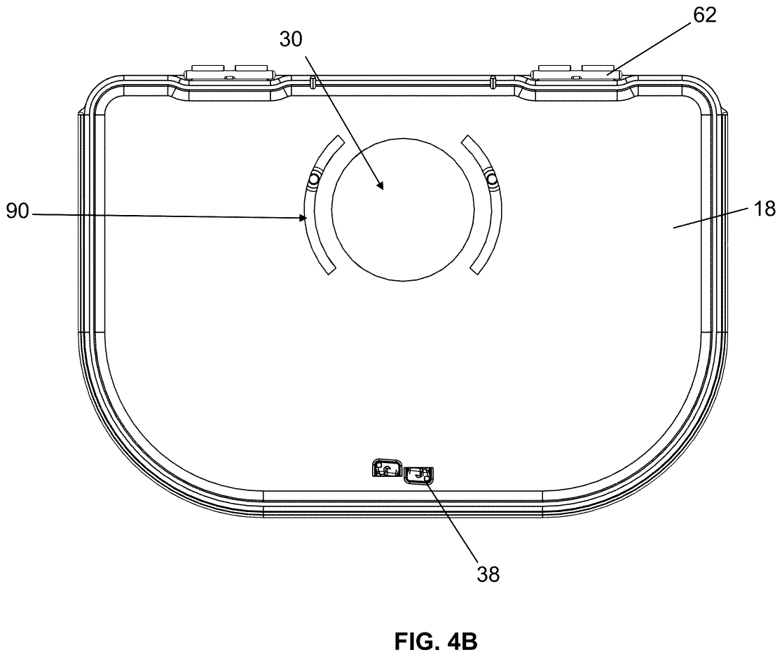

Referring now to FIGS. 4A and 4B, device 10 is shown in a configuration in which grate 22 is not coupled to lid 18. As is shown by the current configuration, lid 18 further defines one or more channel(s) 90. Each of the one or more channel(s) 90 can be configured to receive a corresponding one of the one or more projection(s) 86 of grate 22. Thus, grate 22 can be coupled to lid 18 by inserting each of projection 86 into a respective one of channels 90 (e.g., by deforming grate 22 or projections 86 sufficiently to snap into respective channels). In the depicted configuration, grate 22 comprises plastic or other material that allows for substantially elastic deformation such that, once the projections 86 snap into respective channels 90, the grate will return to substantially an original (pre-deformation) form. In such a configuration, angled or tapered lower portion 88b can facilitate the deformation of grate 22 and guide each of the projections 86 into respective channels 90 (e.g., by applying downward pressure to the grate). In other configurations, the one or more projection(s) 86 and one or more channel(s) 90 are configured such that they engage with each other by rotating the grate into position relative to the lid (e.g., circumferentially narrower projections with radially wider ends on the channels to receive the projections without deformation prior to rotating the grate into position, male and female threads, or the like).

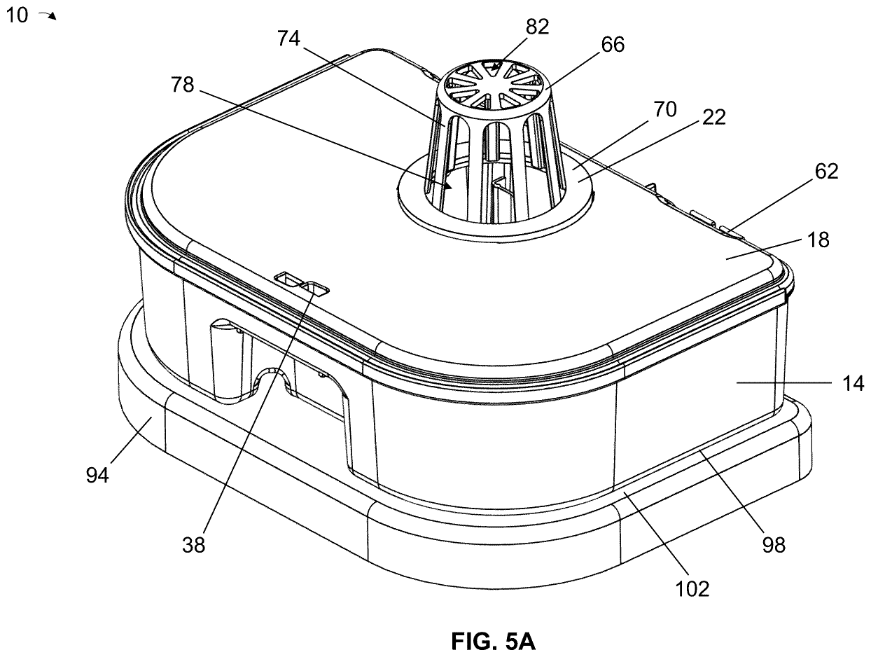

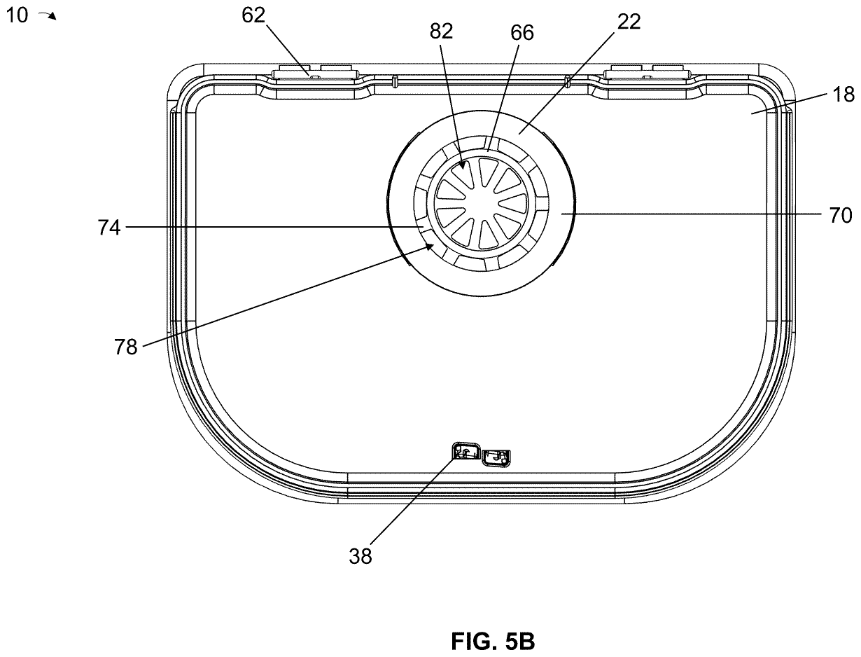

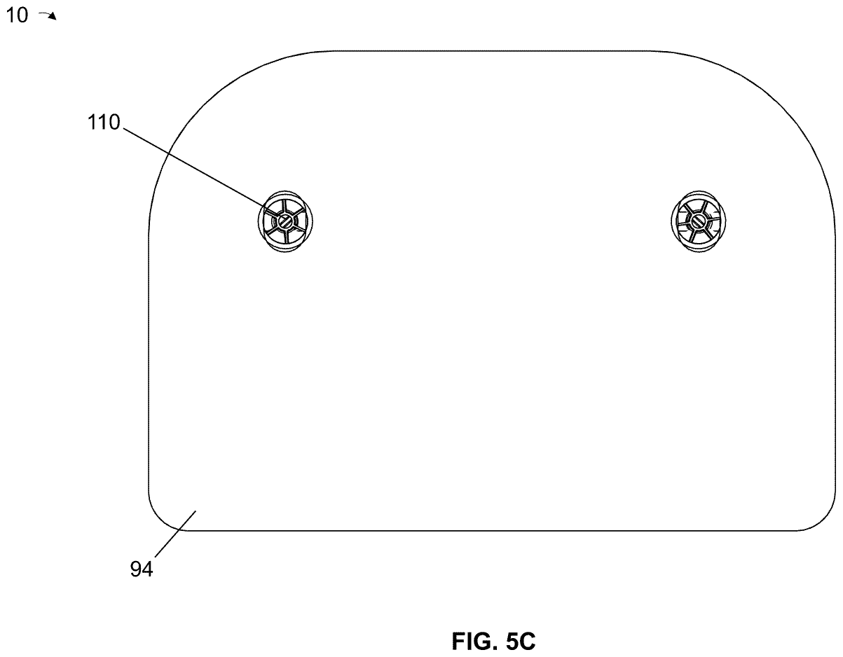

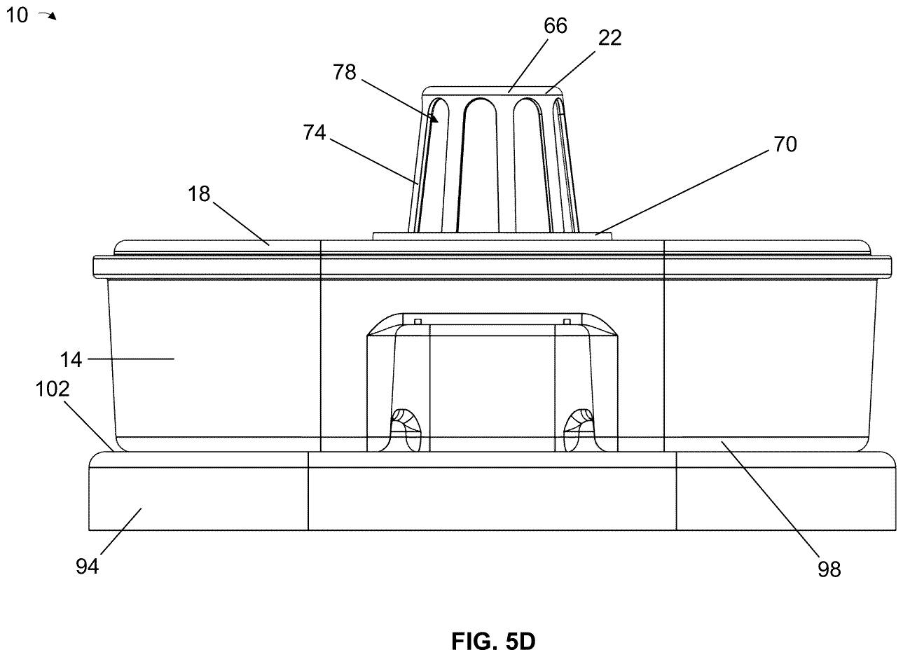

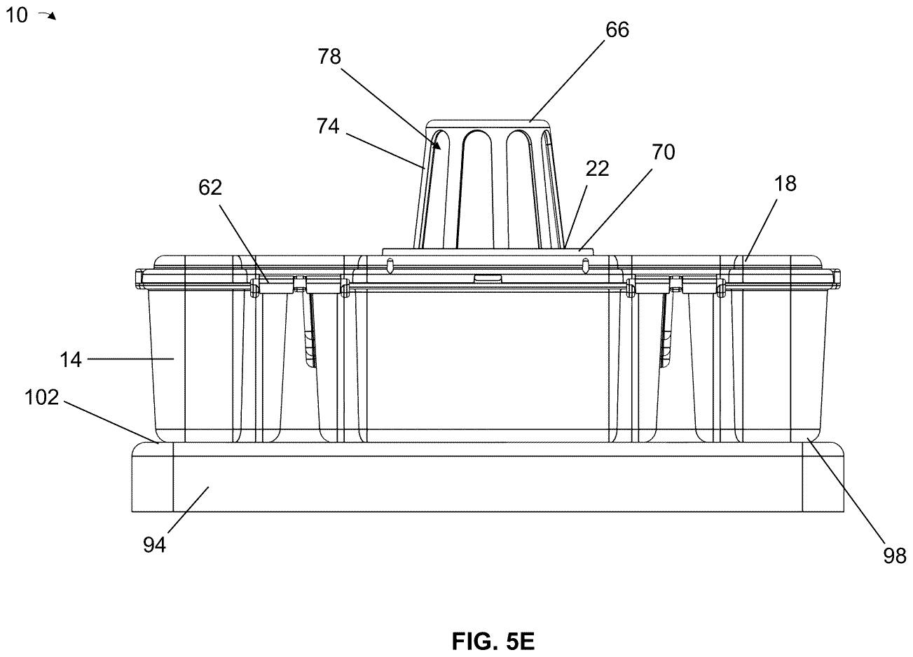

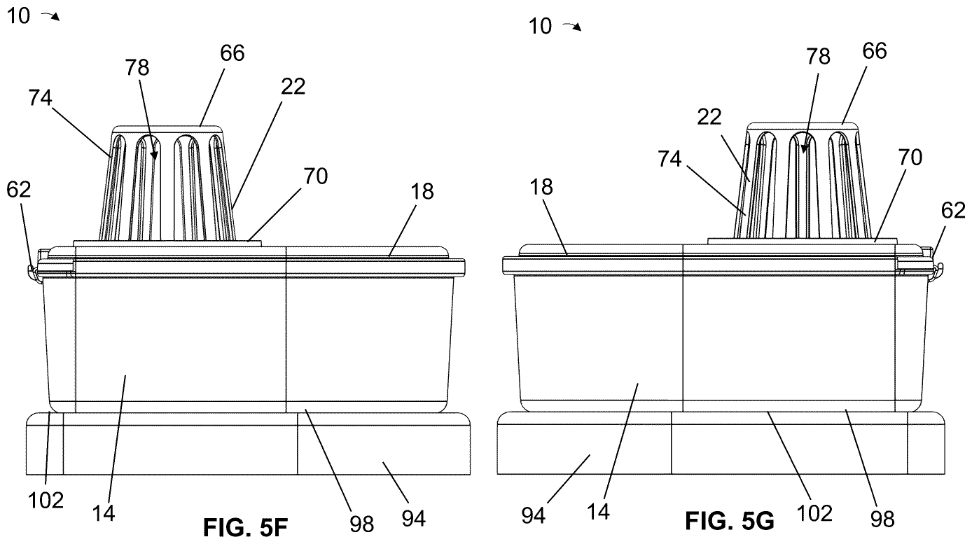

Referring now to FIGS. 5A-5G, device 10 is shown with grate 22 installed for use (e.g., coupled to lid 18 over opening 30) and with an anchoring base 94 further coupled to the device. Anchoring base 94 is utilized to facilitate secure and stable placement of device 10, for example, by acting as an added weight and lowering the center of gravity of the assembly. In some configurations, anchoring base 94 partially or substantially comprises concrete, pre-molded such that the shape of the anchoring base can correspond to at least one feature of device 10. To illustrate, in some configurations, the at least one feature of device 10 comprises a curved portion 98 of a perimeter of the device (e.g., a perimeter of base 14). In such configurations, anchoring base 94 then includes a corresponding curved portion (e.g., to facilitate placement of base 14 in relation to the anchoring base). In yet other configurations, such as the one shown, anchoring base 94 comprises a substantially flat anchoring base top surface 102. Preferably, anchoring base 94 is coupled to base 10 such that it is securely attached thereto and acts as a weight or “anchor” for device 10. Anchoring base 94 can thus prove beneficial, for example, in the case of heavy winds which could undesirably move device 10 (e.g., as opposed to a configuration in which device did not have an anchoring base attached). To further illustrate, anchoring base top surface 102, by being at least substantially flat, can be at least partially in contact with base 14. In some configurations, anchoring base 94 includes one or more anchoring base attachment surface(s) 104 that are not parallel to anchoring base top surface 102. The one or more anchoring base attachment surface(s) 104 can be used to facilitate coupling of anchoring base 94 to base 14, as will be described in the following paragraphs.

Referring now to FIGS. 6A-7, device 10 is shown in the open configuration (wherein lid 18 is open relative to base 14). Additionally, as is shown, grate 22 is disposed within interior chamber 26 (e.g., within central cavity 50) and anchoring base 94 is shown disposed against and coupled to base 14. In some configurations, such as the one shown in FIG. 6A, the lid includes a plurality of ridges 106 that define a plurality of cells 108 in which insects (e.g., mosquitos) can nest and/or lay eggs. In the example shown, lid 18 includes a plurality of ridges 106a extending in a first direction, and a plurality of second ridges 106b extending in a second direction that is not parallel (e.g., perpendicular) to the first direction, such that the intersecting ridges define more than ten cells (e.g., between ten and twenty cells, or more than twenty cells). In some configurations, such as the depicted example, the cells (108) are spaced from the opening (30) in the lid corresponding to the grate (22), such that the cells are always in shadow relative to any light passing through the opening.

As is shown best in FIGS. 6B, 6C, and 7, device 10 includes one or more attachment piece(s) 110, each in contact with a respective one of the one or more anchoring base attachment surface(s) 104. Device 10 additionally includes one or more fastening member(s) 114 in contact with base 14, wherein each fastening member is coupled to a respective one or the one or more attachment piece(s) 110. Using at least these structures, anchoring base 94 can be coupled to base 14 by a compressive force that is normal to anchoring base top surface 102 (e.g. the compressive force being applied to the anchoring base by the one or more attachment piece(s) 110). The one or more attachment piece(s) 110 are not integral to anchoring base 94 prior to coupling a respective one of the one or more fastening member(s) 114 to the one or more attachment piece(s). However, in other configurations, the one or more attachment piece(s) 110 are integral to anchoring base 94 prior to coupling a respective one of the one or more fastening member(s) 114 to the one or more attachment piece(s). In at least this way, device 10 can be stored, shipped, or packaged with or without anchoring base 94 attached (e.g., to better suit a specific user's needs). As previously described, pre-manufacturing and coupling anchoring base 94 to device 10 can benefit a user by reducing setup time and additional costs.

Referring now to FIG. 7, one example of the one or more attachment piece(s) 110 and one or more fastening member(s) 114 used to couple anchoring base 94 to base 14 is shown in a section view. In the depicted configuration, the one or more attachment piece(s) 110 comprise frusto-conically-shaped fastening plugs that are each in contact with a respective one of the one or more fastening member(s) 114. Additionally, the one or more anchoring base attachment surface(s) 106 of anchoring base 94 are frusto-conically shaped to accommodate the attachment piece(s) 110. In other configurations, the one or more attachment piece(s) 110 and one or more fastening member(s) 114 can comprise any suitable combination of fastening components such as hex bolts, socket screws, hex nuts, wing nuts, cap nuts, rivets, or the like to provide the aforementioned compressive force. In such configurations in which other components are used, the one or more anchoring base attachment surface(s) 106 can be sized and shaped to better accommodate such fastening components (e.g., comprising a hexagonal shape to accommodate a hex nut or comprising a flat surface to accommodate a wing nut). In yet other configurations, alternative means for attachment of anchoring base 94 to base 14 are used, such as liquid adhesives, solid adhesives, an adhesive film, or the like disposed between anchoring base top surface 102 and the base.

In some configurations, device 10 additionally comprises an attachment tray 118 (FIG. 7). In some configurations, attachment tray 118 comprises plastic and can be disposed around at least a portion of anchoring base 94. Attachment tray 118 can be included to protect and potentially contain fragments of anchoring base 94 that are prone to breaking or fragmenting (e.g., embodiments comprising concrete). Additionally, attachment tray 118 can serve to prevent excess leakage from device 10 (e.g., in the case of base 14 and anchoring base 94 being broken, punctured, or otherwise damaged). In some configurations, the one or more attachment piece(s) 110 are part of attachment tray 118.

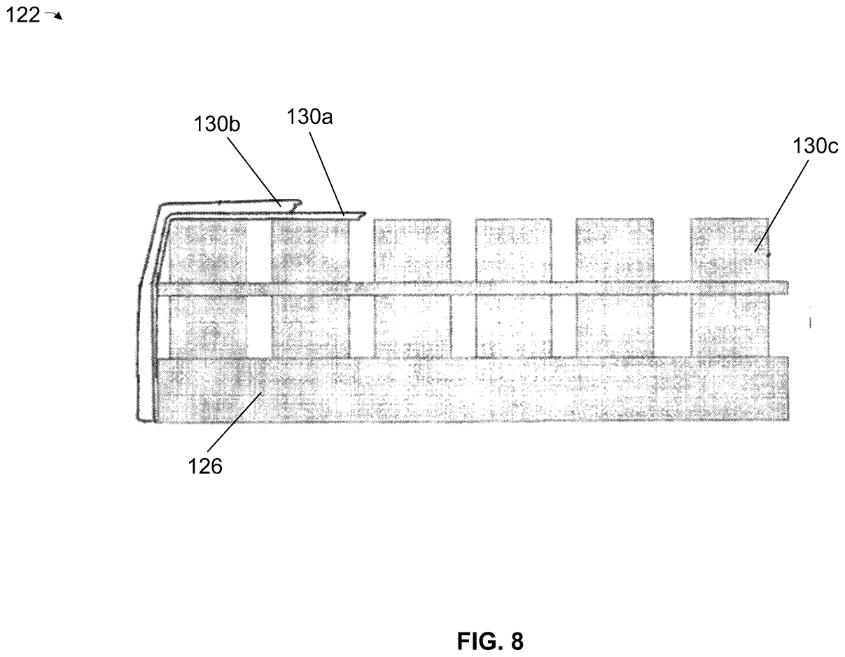

Referring now to FIG. 8, one example of a pest control device 10 packaged bundle 122 is shown. To illustrate, packaged bundle 122 can be used to facilitate the shipping, storage, or the like of multiple devices 10. In some configurations, packaged bundle 122 comprises a pallet 126, multiple devices 10 positioned on the pallet, and a means for securement 130. In some configurations, anchoring base 94 is attached to base 14 before each device 10 is packaged. However, in other configurations, anchoring base 94 is packaged separately (e.g., separately from device 10), or alternatively, not included. As previously discussed, pre-attaching anchoring base 94 to base 14 can prove beneficial to a user by reducing setup time and/or costs once they receive device 10. For example, some pest control devices currently sold require the user to make and/or attach an anchoring base after receiving the device, which can add costs and delays for the user. The means for securement 130 comprises a film 130a wrapped around at least a portion of the multiple devices 10, one or more strap(s) 130b wrapped around at least a portion of the multiple devices, one or more packaging container(s) 130c wrapped around or otherwise surrounding one or more of the multiple devices, or a combination thereof. By using one or more of film 130a, strap(s) 130b, or packaging container(s) 130c, the multiple devices 10 can be secured to pallet 126 to facilitate safe and secure transportation of the multiple devices. In some configurations, packaged bundle 122 additionally comprises one or more key(s) 42 (e.g., one key for all devices 10 in the packaged bundle or a set of keys for the multiple devices). Alternatively, a key 42 is provided for each device 10 of the multiple devices in packaged bundle 122 (e.g., a key is temporarily coupled to the exterior of each device or package, or an additional package or container contains the multiple keys for the devices).

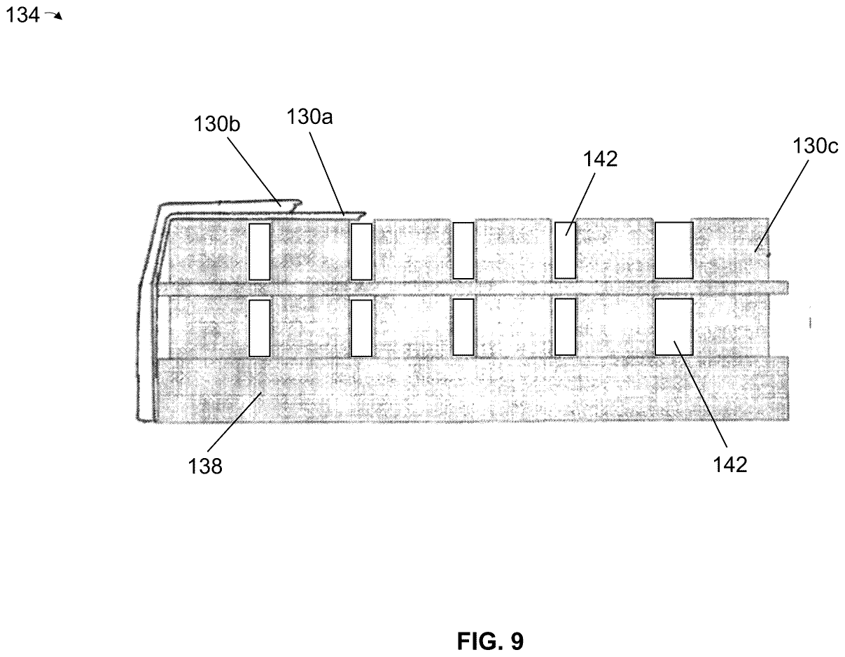

Referring now to FIG. 9, one embodiment of a shipping bundle 134 is shown. Functioning as an alternative to packaged bundle 122, multiple devices 10 can be packaged and shipped by means of shipping bundle 134. Shipping bundle 134 can function in substantially the same manner as packaged bundle 122. To illustrate, shipping bundle 134 can be used to facilitate the shipping, storage, or the like of multiple devices 10. In some configurations, shipping bundle 134 comprises a transport pallet 138, multiple devices 10 positioned on the transport pallet, and a means for securement 130. In some configurations, anchoring base 94 is attached to base 14 before each device 10 is packaged. However, in other configurations, anchoring base 94 is packaged separately (e.g., separately from device 10), or alternatively, not included. In some configurations, the means for securement 130 comprises a film 130a wrapped around at least a portion of the multiple devices 10, one or more strap(s) 130b wrapped around at least a portion of the multiple devices, one or more packaging container(s) 130c wrapped around or otherwise surrounding one or more of the multiple devices, or a combination thereof. By using one or more of film 130a, strap(s) 130b, or packaging container(s) 130c, the multiple devices 10 can be secured to transport pallet 138 to facilitate safe and secure transportation or shipping of the multiple devices. In the depicted configuration, shipping bundle 134 comprises additional packing material 142 to further facilitate securement of the multiple devices 10 by further restricting movement of the devices relative to each other and to transport pallet 138. In some configurations, shipping bundle 134 comprises one or more key(s) 42 (e.g., one key for all devices 10 in the packaged bundle or multiple keys for the devices). Alternatively, in other configurations, a key 42 is provided for each device 10 of the multiple devices in shipping bundle 134 (e.g., a key is temporarily attached to the exterior of each device or package, or an additionally package or container contains the multiple keys for the devices).

Some of the present methods of assembling the present pest control device (e.g., 10) comprise: opening the lid (e.g., 18), removing the grate (e.g., 22) from the interior chamber (e.g., 26) of the device, closing the lid, and attaching the grate to the lid. Specifically, to facilitate shipping, the grate can be held within the central cavity (e.g., 50). After receiving or otherwise acquiring the pest control device, a user can remove the grate from the central cavity of the device and couple the grate to the lid. In other configurations, assembling the pest control device comprises: inserting a key (e.g., 42) into the key opening (e.g., 38) to actuate the lock mechanism (e.g., 34), opening the lid, removing the grate from the interior chamber of the pest control device, closing the lid, and attaching the grate to the lid.

Some of the present methods of attaching the grate to the lid comprise inserting the one or more projection(s) (e.g., 86) into a corresponding one of the one or more channel(s) (e.g., 90) defined by the lid. In some configurations, attaching the grate to the lid comprises: deforming the grate, rotating the grate, applying downward pressure to the grate, or a combination thereof to fit the one or more projection(s) into a corresponding one of the one or more channel(s) in the lid.

In some configurations, device 10 and components, portions, or parts thereof are colored to facilitate the attraction of pests (e.g., mosquitos). For example, colors such as red and black have been shown to attract mosquitos. As such, some configurations of device 10 comprise components or portions of components that are colored red or black to better facilitate the attraction of mosquitos. To further illustrate, in some configurations, grate 22 is colored red to better attract mosquitos. When within a certain proximity of device 10 (e.g., grate 22), the humidity of device 10 (e.g., from liquid disposed within interior chamber 26) can further attract mosquitos into the device.

While the present description is directed towards the attraction and control of mosquito populations, it should be noted that device 10 can be modified to attract other suitable insect or pest species while remaining within the scope of claims.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the apparatuses, systems, and methods are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure and/or connections may be substituted. Further, where appropriate, aspects of any of the examples described above may be combined with aspects of any of the other examples described to form further examples having comparable or different properties and/or functions and addressing the same or different problems. Similarly, it will be understood that the benefits and advantages described above may relate to one embodiment or may relate to several embodiments.

The claims are not intended to include, and should not be interpreted to include, means- plus- or step-plus-function limitations, unless such a limitation is explicitly recited in a given claim using the phrase(s) “means for” or “step for,” respectively.

1. A pest control device comprising:
a base comprising plastic;
a lid comprising plastic configured to be movable relative to the base between an open configuration and a closed configuration in which the base and the lid cooperate to define an interior chamber, the lid defining an opening extending through the lid; and
a grate configured to be coupled to the lid such that:
the grate covers the opening; and
when the lid is in the closed configuration relative to the base, the grate extends away from the interior chamber.

2. The device of claim 1, further comprising:
an anchoring base comprising concrete that is pre-molded to correspond to at least one feature of the pest control device.

3. The device of claim 1, wherein the lid is movable relative to the base.

4. The device of claim 3, wherein the lid is pivotably coupled to the base.

5. The device of claim 1, wherein the grate is configured to be removably disposed within the chamber when the lid is in the closed configuration relative to the base.

6. The device of claim 5, wherein the grate comprises an upper end, a lower end, and one or more peripheral sidewalls extending between the upper end and the lower end, where the lower end is configured to engage the lid to couple the grate to the lid.

7. The device of claim 6, wherein the one or more sidewalls of the grate each define a plurality of openings.

8. The device of claim 7, wherein:
when the grate is coupled to the lid:
the openings defined by the grate are configured to permit mosquitos to enter the chamber; and
the upper end of the grate is configured to prevent rainfall from entering the chamber through the upper end.

9. The device of claim 6, wherein the lid further defines one or more channels configured to receive corresponding projections of the lower end of the grate.

10. The device of claim 9, where the lower end of the grate includes one or more projections configured to extend into corresponding ones of the one or more channels in the lid.

11. The device of claim 1, where the lid defines a plurality of hollow cells on an interior side of the lid.

12. The device of claim 11, where the lid comprises first and second pluralities of ridges extending into the interior chamber when the lid is in the closed configuration relative to the base, the first plurality of ridges intersecting the second plurality of ridges to define the cells.

13. The device of claim 1, further comprising:
a lock mechanism configured to latch to resist separation of the lid from the base when the lid is in the closed configuration relative to the base.

14. The device of claim 13, where the lid defines a key opening configured to permit access to the lock mechanism, and the device further comprises:
a key configured to be inserted through the key opening to actuate the lock mechanism.

15. The device of claim 2, wherein the anchoring base is configured to be coupled to the base.

16. The device of claim 15, wherein the at least one feature of the pest control device includes a curved portion of a perimeter of the pest control device and the anchoring base includes a first curved portion that corresponds to the curved portion of the perimeter of the pest control device.

17. A shipping bundle comprising:
a transport pallet;
a plurality of pest control devices, each comprising:
a base comprising plastic;
a lid comprising plastic configured to be movable relative to the base between an open configuration and a closed configuration in which the base and the lid cooperate to define an interior chamber, the lid defining an opening extending through the lid;
a grate configured to be coupled to the lid such that:
the grate covers the opening; and
when the lid is in the closed configuration relative to the base, the grate extends away from the interior chamber; and
a means for securement.

18. The shipping bundle of claim 17, wherein each of the pest control devices includes an anchoring base comprising concrete that is pre-molded to correspond to at least one feature of the pest control device.

19. The shipping bundle of claim 17, wherein the means for securement comprises a plastic film wrapped around a portion of the plurality of pest control devices to secure the pest control devices to the transport pallet and restrict movement of pest control devices relative to each other.

20. A method of assembling the pest control device of claim 1, the method comprising:
opening the lid;
removing the grate from the chamber of the pest control device;
closing the lid; and
attaching the grate to the lid.
